(19) United States
(12) Patent Application Publication
(10) Pub. No.: US 2015/0277823 A1
(43) Pub. Date: Oct. 1, 2015

(54) PRINTER APPARATUS, PRINTING METHOD, AND NON-TRANSITORY COMPUTER READABLE MEDIUM

(71) Applicant: FUJI XEROX CO., LTD., Tokyo (JP)

(72) Inventor: Hidetomo NAKAYAMA, Kanagawa (JP)

(73) Assignee: FUJI XEROX CO., LTD., Tokyo (JP)

(21) Appl. No.: 14/494,775

(22) Filed: Sep. 24, 2014

(30) Foreign Application Priority Data
Mar. 28, 2014 (JP) 2014-068870

(51) Int. Cl. G06F 3/12; G03G 15/00

(52) U.S. Cl. CPC G06F 3/1238; G03G 15/5091; G03G 15/5087; G06F 3/1292

(57) ABSTRACT

A printer apparatus includes a near field wireless communication unit; a printing unit; a receiving unit that receives printing data from an information processing apparatus; an accepting unit that accepts authentication information; a first controller that controls the printing unit so that the printing data received by the receiving unit is printed if authentication using the authentication information accepted by the accepting unit becomes successful; and a second controller that controls the printing unit so that the printing data is printed without the authentication using the authentication information if the printing data is received by the receiving unit after near field wireless communication with the information processing apparatus by the near field wireless communication unit is performed.

### CROSS-REFERENCE TO RELATED APPLICATIONS

This application is based on and claims priority under 35 USC 119 from Japanese Patent Application No. 2014-068870 filed Mar. 28, 2014.

### BACKGROUND

### Technical Field

The present invention relates to a printer apparatus, a printing method, and a non-transitory computer readable medium.

### SUMMARY

According to an aspect of the invention, there is provided a printer apparatus including a near field wireless communication unit; a printing unit; a receiving unit that receives printing data from an information processing apparatus; an accepting unit that accepts authentication information; a first controller that controls the printing unit so that the printing data received by the receiving unit is printed if authentication using the authentication information accepted by the accepting unit becomes successful; and a second controller that controls the printing unit so that the printing data is printed without the authentication using the authentication information if the printing data is received by the receiving unit after near field wireless communication with the information processing apparatus by the near field wireless communication unit is performed.

### BRIEF DESCRIPTION OF THE DRAWINGS

Exemplary embodiments of the present invention will be described in detail based on the following figures, wherein:

FIG. 1 illustrates an exemplary printing system;

FIG. 2 illustrates an exemplary hardware configuration of a printer apparatus;

FIG. 3 is a block diagram illustrating an exemplary hardware configuration of an information processing apparatus;

FIG. 4 is a block diagram illustrating an exemplary functional configuration of the printer apparatus;

FIG. 5 is a flowchart illustrating an exemplary operational process in a first exemplary embodiment;

FIG. 6 is a flowchart illustrating an exemplary operational process in a second exemplary embodiment; and

FIG. 7 is a flowchart illustrating the exemplary operational process in the second exemplary embodiment.

### DETAILED DESCRIPTION

### First Exemplary Embodiment

A first exemplary embodiment of the present invention will now be described.

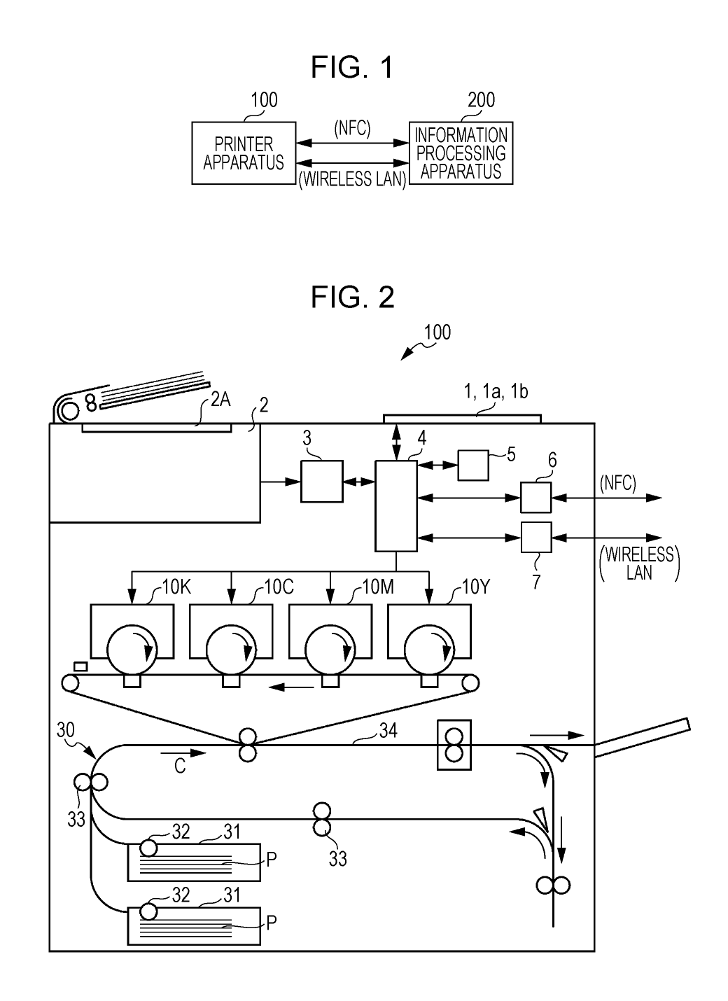

FIG. 1 illustrates an exemplary printing system. Referring to FIG. 1, the printing system includes a printer apparatus 100 and an information processing apparatus 200. The information processing apparatus 200 is, for example, a mobile terminal, such as a smartphone. The information processing apparatus 200 transmits printing data to the printer apparatus 100, which prints an image based on the printing data. The printer apparatus 100 and the information processing apparatus 200 have a function to perform near field wireless communication and a function to perform communication over a wireless local area network (LAN).

FIG. 2 illustrates an exemplary hardware configuration of the printer apparatus 100. Referring to FIG. 2, a control unit 4 includes arithmetic devices including a central processing unit (CPU) and memories including a read only memory (ROM) and a random access memory (RAM) (the arithmetic devices and the memories are not illustrated in FIG. 2). Hardware and firmware in which the procedure for starting the operating system (OS) is described are stored in the ROM. The RAM is used to store data when the CPU executes arithmetic operations. A storage unit 5 includes, for example, a hard disk storage device and stores the OS and application programs.

A near field wireless communication unit 6 is a communication interface for communication with the information processing apparatus 200 through near field communication (NFC). The near field wireless communication unit 6 is, for example, a reader-writer that communicates with a non-contact integrated circuit (IC) card provided in the information processing apparatus 200. The near field wireless communication in the present exemplary embodiment means a communication unit having a communication range of about several centimeters to about several tens centimeters and includes the NFC and Bluetooth (registered trademark). The NFC is used as the near field wireless communication in the following examples. The standard of the NFC is, for example, International Organization for Standardization (ISO)/International Electrotechnical Commission (IEC) 18092. The near field wireless communication unit 6 is provided at a position adjacent to a user interface (UI) unit 1 and a mark indicating the position of the near field wireless communication unit 6 is put outside a housing of the printer apparatus 100. The near field wireless communication unit 6 periodically sends a query signal and a near field wireless communication unit 203 in the information processing apparatus 200 receives the query signal when a user holds the information processing apparatus 200 over the position of the mark. Upon reception of the query signal, the near field wireless communication unit 203 sends a response signal and a session of the NFC is established between the printer apparatus 100 and the information processing apparatus 200 upon reception of the response signal by the near field wireless communication unit 6. When no response signal is received in response to the query signal, the session of the NFC is terminated.

A wireless LAN communication unit 7 is a communication interface to connect the printer apparatus 100 to the wireless LAN. The standard of the wireless LAN is, for example, any of Institute of Electrical and Electronic Engineers (IEEE) 802.11 series. The wireless LAN in the present exemplary embodiment is the wireless LAN in an ad hoc mode, in which the information processing apparatus 200 directly communicates with the printer apparatus 100 without via an access point.

The printer apparatus 100 may include a communication interface to connect the printer apparatus 100 to a wired communication LAN and/or a communication function, such as a modem, which connects the printer apparatus 100 to a telephone line to transmit and receive image data to and from a facsimile apparatus.

A reader unit 2 optically scans a document to generate image data. Specifically, the reader unit 2 includes a light source, an optical system, and an imaging element (not illustrated). A document mounted on a platen glass 2A is irradiated with light emitted the light source and reflected light reflected from the document is separated into red (R), green (G), and blue (B) via the optical system to be incident on the imaging element. The imaging element converts the incident light into a signal to supply the signal to an image processing unit 3.

The image processing unit 3 performs image processing to the image data to generate image data representing gradation of each color and of each pixel. Specifically, the image processing unit 3 performs analog-digital (A/D) conversion to the signal supplied from the reader unit 2 to perform, for example, shading correction, gamma correction, noise reduction, conversion of red (R), green (G), and blue (B) into yellow (Y), magenta (M), cyan (C), and black (K), and screen processing to the digital signal. The image processing unit 3 has a function to convert the printing data described in a page description language (PDL) into raster data. When the image processing unit 3 receives the printing data from the outside, the image processing unit 3 converts the received printing data into the raster data to perform the above image processing to the raster data.

A transport unit 30 conveys each recording medium P along a transport path 34. Specifically, the sheet-like recording media P, such as sheets of paper, are stacked for storage in each medium housing unit 31. Each delivery roller 32 delivers the recording media P one by one on the transport path 34. Each transport roller 33 conveys the recording medium P along the transport path 34 in the direction of an arrow C.

Image forming units 10Y, 10M, 10C, and 10K generate toner images of yellow, magenta, cyan, and black using an electrophotographic method on the basis of the raster data supplied from the image processing unit 3 and superimposes the toner images on the recording medium P for transfer. The image forming units 10Y, 10M, 10C, and 10K are hereinafter collectively referred to as an image forming unit 10.

The UI unit 1 includes a display 1a and an accepting portion 1b. The display 1a is a display unit using, for example, liquid crystal or an organic electro-luminescence (EL) element and has a planar display surface. The display 1a displays an operation screen used by the user to operate the printer apparatus 100. Virtual operators (so-called icons) corresponding to the functions of the printer apparatus 100 are arranged on the operation screen.

The accepting portion 1b accepts an operation by the user for the printer apparatus 100. The accepting portion 1b is, for example, a touch panel provided so as to be over the display surface of the display 1a. The user performs the operation for the printer apparatus 100 while watching the operation screen displayed in the display 1a through the touch panel. Upon touching of the accepting portion 1b by the user with his/her finger, the accepting portion 1b supplies contact position information indicating the contact position of the finger to the control unit 4. The control unit 4 identifies the content of the operation on the basis of the contact position information to operate the printer apparatus 100 in accordance with the content of the operation.

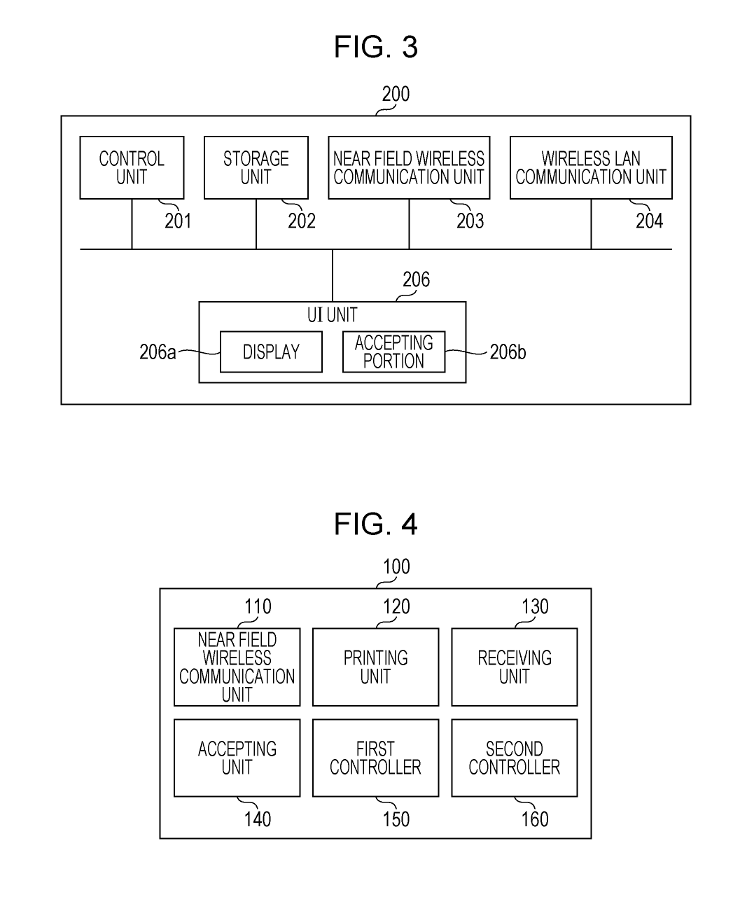

FIG. 3 is a block diagram illustrating an exemplary hardware configuration of the information processing apparatus 200. Referring to FIG. 3, the information processing apparatus 200 includes a control unit 201, a storage unit 202, the near field wireless communication unit 203, a wireless LAN communication unit 204, and a UI unit 206. The control unit 201 includes arithmetic devices including a CPU and memories including a ROM and a RAM (the arithmetic devices and the memories are not illustrated in FIG. 3). Hardware and firmware in which the procedure for starting the OS is described are stored in the ROM. The RAM is used to store data when the CPU executes arithmetic operations. The storage unit 202 includes memories, such as an electrically erasable and programmable read only memory (EEPROM) and a static random access memory (SRAM), and stores the OS, application programs, and so on. A printer driver corresponding to the printer apparatus 100 is stored in the storage unit 202.

The near field wireless communication unit 203 is a communication interface for communication with the near field wireless communication unit 6 in the printer apparatus 100 through the NFC. For example, the near field wireless communication unit 203 includes a non-contact IC card and a slot in which the non-contact IC card is loaded. The wireless LAN communication unit 204 is a communication interface to connect the information processing apparatus 200 to the wireless LAN.

The information processing apparatus 200 may include a communication interface to connect the information processing apparatus 200 to a communication network of mobile phones and may include, for example, a speaker, a microphone, and an audio processing circuit for talking.

The UI unit 206 includes a display 206a and an accepting portion 206b. The display 206a is a display unit using, for example, liquid crystal or an organic EL element and has a planar display surface. The control unit 201 displays an operation screen used by the user to operate the information processing apparatus 200 in the display 206a. Virtual operators (so-called icons) corresponding to the functions of the information processing apparatus 200 are arranged on the operation screen.

The accepting portion 206b accepts an operation by the user for the information processing apparatus 200. The accepting portion 206b is, for example, a touch panel provided so as to be over the display surface of the display 206a. The user performs the operation for the information processing apparatus 200 while watching the operation screen displayed in the display 206a through the touch panel. Upon touching of the accepting portion 206b by the user with his/her finger, the accepting portion 206b supplies contact position information indicating the contact position of the finger to the control unit 201. The control unit 201 identifies the content of the operation on the basis of the contact position information to operate the information processing apparatus 200 in accordance with the content of the operation. In addition to the touch panel, push-button keys used for inputting numbers or the likes may be provided.

Printing process types will now be described. The major types of the printing process are as follows: Accumulated printing (a first type): The user inputs authentication information into the information processing apparatus 200. The authentication information is, for example, a password composed of a number of multiple digits. The information processing apparatus 200 transmits the printing data to which the input authentication information and a user identifier (ID) set in the information processing apparatus 200 in advance are added to the printer apparatus 100. The printer apparatus 100 stores (accumulates) the received printing data in the storage unit 5. Upon selection of the accumulated printing from a menu displayed in the printer apparatus 100 by the user, the user ID corresponding to each piece of the printing data that is accumulated is displayed. Upon selection of a user ID and input of the authentication information by the user, the printer apparatus 100 reads out the printing data to which the user ID and the authentication information are added from the storage unit 5 to print an image based on the printing data.

Normal printing (a second type): The printer apparatus 100 prints an image based on the printing data as soon as the printer apparatus 100 receives the printing data.

FIG. 4 is a block diagram illustrating an exemplary functional configuration of the printer apparatus 100. The functions illustrated in FIG. 4 are realized by the control unit 4 that operates the hardware of the printer apparatus 100 in accordance with the procedure described in the programs.

Referring to FIG. 4, the printer apparatus 100 includes a near field wireless communication unit 110, a printing unit 120, a receiving unit 130, an accepting unit 140, a first controller 150, and a second controller 160. The near field wireless communication unit 110 performs the near field wireless communication with the information processing apparatus 200. The printing unit 120 prints the printing data. The receiving unit 130 receives the printing data from the information processing apparatus 200. The accepting unit 140 accepts the authentication information. The first controller 150 controls the printing unit 120 so that the printing data received by the receiving unit 130 is printed if authentication using the authentication information accepted by the accepting unit 140 succeeded. The second controller 160 controls the printing unit 120 so that the printing data is printed without the authentication using the authentication information if the printing data is received by the receiving unit 130 after the near field wireless communication with the information processing apparatus 200 by the near field wireless communication unit 110 is performed.

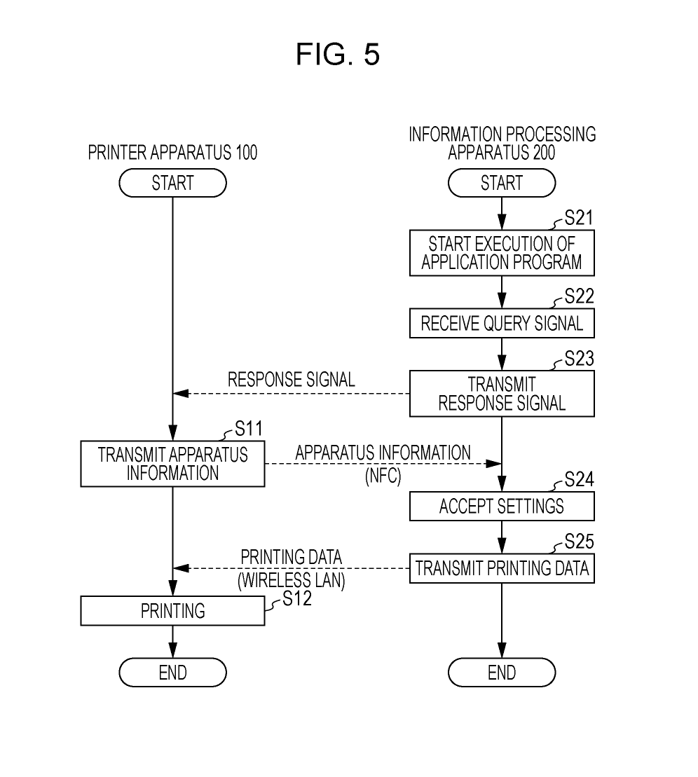

FIG. 5 is a flowchart illustrating an exemplary operational process in the first exemplary embodiment. The near field wireless communication unit 6 in the printer apparatus 100 continues to periodically send the query signal.

Referring to FIG. 5, in Step S21, the control unit 201 in the information processing apparatus 200 starts execution of an application program. Specifically, the user of the information processing apparatus 200 instructs the information processing apparatus 200 to execute the application program. The application program is a program for executing, for example, display of a document, editing, or printing. Upon start of the execution of the application program, the user selects a document to be printed to cause the display 206a to display the document and instructs the information processing apparatus 200 to start to make settings concerning the printing.

In Step S22, the near field wireless communication unit 203 receives the query signal sent from the near field wireless communication unit 6 in the printer apparatus 100.

In Step S23, the control unit 201 transmits the response signal to the printer apparatus 100 with the near field wireless communication unit 203.

In Step S11, upon reception of the response signal by the near field wireless communication unit 6 (the near field wireless communication unit 110), the NFC with the information processing apparatus 200 is established. The control unit 4 transmits apparatus information and an IP address to the information processing apparatus 200 with the near field wireless communication unit 6. The apparatus information is, for example, information indicating the model of the printer apparatus 100. The IP address is the IP address allocated to the wireless LAN communication unit 7 and is used as the destination address when the printing data is transmitted from the information processing apparatus 200 to the printer apparatus 100 via the wireless LAN.

In Step S24, the control unit 201 receives the apparatus information and the IP address. The control unit 201 reads out the printer driver corresponding to the model of the printer apparatus 100 from the storage unit 5 on the basis of the received apparatus information and displays a setup screen of the printer driver in the display 1a. The user sets print parameters on the setup screen and instructs transmission of the printing data. The print parameters include a printing range, the number of copies, and one side printing or duplex printing.

In Step S25, the control unit 201 transmits the printing data to the printer apparatus 100. Specifically, the control unit 201 generates the printing data corresponding to the parameters (for example, the printing range, the number of copies, the one side printing or the duplex printing) set in Step S24 and transmits the printing data to the printer apparatus 100 with the wireless LAN communication unit 204. The printing data to be generated may be data described in the page description language (PDL) or may be data described in combination of the PDL and a printer job language (PJL). The printing data may be data representing an image to be printed or may be data including the address of the location where the data representing the image to be printed is stored.

In Step S12, the control unit 4 (the second controller 160) supplies the printing data received from the information processing apparatus 200 to the image processing unit 3. The image processing unit 3 (the printing unit 120) converts the printing data into the raster data to perform the image processing to the raster data and supplies the raster data subjected to the image processing to the image forming unit 10. The image forming unit 10 prints an image based on the raster data. Upon completion of the printing, the process concerning the printing data is terminated.

When the printer apparatus 100 receives the printing data in a state in which the response signal is not received from the information processing apparatus 200, the control unit 4 stores the printing data in the storage unit 5. Then, the process concerning the printing data is terminated. In response to the subsequent instruction to execute the accumulated printing to the UI unit 1 from the user, the control unit 4 displays the user ID corresponding to each piece of printing data that is accumulated in the display 1a. Upon selection of a user ID and input of the authentication information by the user, the accepting portion 1b (the accepting unit 140) accepts the user ID and the authentication information to supply the user ID and the authentication information to the control unit 4. The control unit 4 (the first controller 150) reads out the printing data to which the user ID and the authentication information are added from the storage unit 5 to cause the image forming unit 10 (the printing unit 120) to print the printing data.

### Second Exemplary Embodiment

A second exemplary embodiment of the present invention will now be described. The functions described below are realized by the control unit 4 that operates the hardware of the printer apparatus 100 in accordance with the procedure described in the programs.

The near field wireless communication unit 110 performs the near field wireless communication with the information processing apparatus 200. The printing unit 120 prints the printing data. The receiving unit 130 receives the printing data from the information processing apparatus 200. The accepting unit 140 accepts the authentication information. The first controller 150 controls the printing unit 120 so that the printing data received by the receiving unit 130 is printed if the authentication using the authentication information accepted by the accepting unit 140 succeeded. The first controller 150 determines that the authentication succeeded if the authentication information added to the printing data received by the receiving unit 130 coincides with the authentication information accepted by the accepting unit 140.

The second controller 160 causes the printing unit 120 to print the printing data without the authentication using the authentication information if communication information is added to the printing data received by the receiving unit 130, the near field wireless communication with the information processing apparatus 200 is kept, and the communication information added to the printing data coincides with the communication information concerning the near field wireless communication that is kept. The communication information is used to identify the session of the near field wireless communication with the printer apparatus 100. The second controller 160 performs the authentication using the authentication information accepted by the accepting unit 140 if the near field wireless communication with the information processing apparatus 200 is not kept and causes the printing unit 120 to print the printing data if the authentication succeeded.

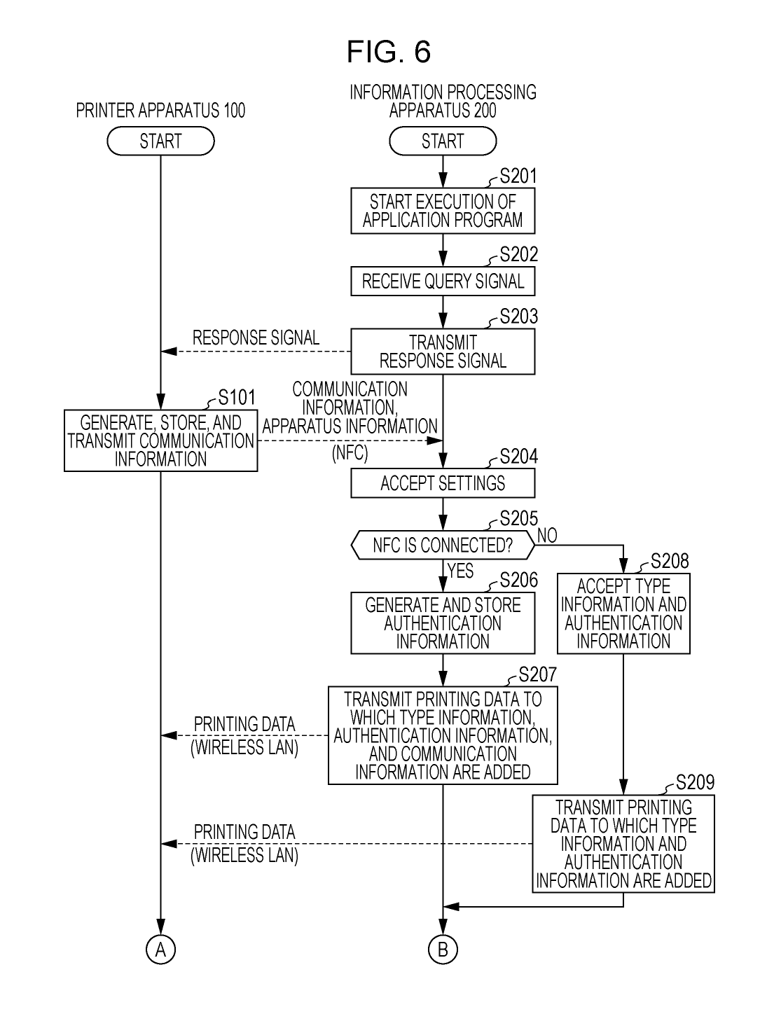

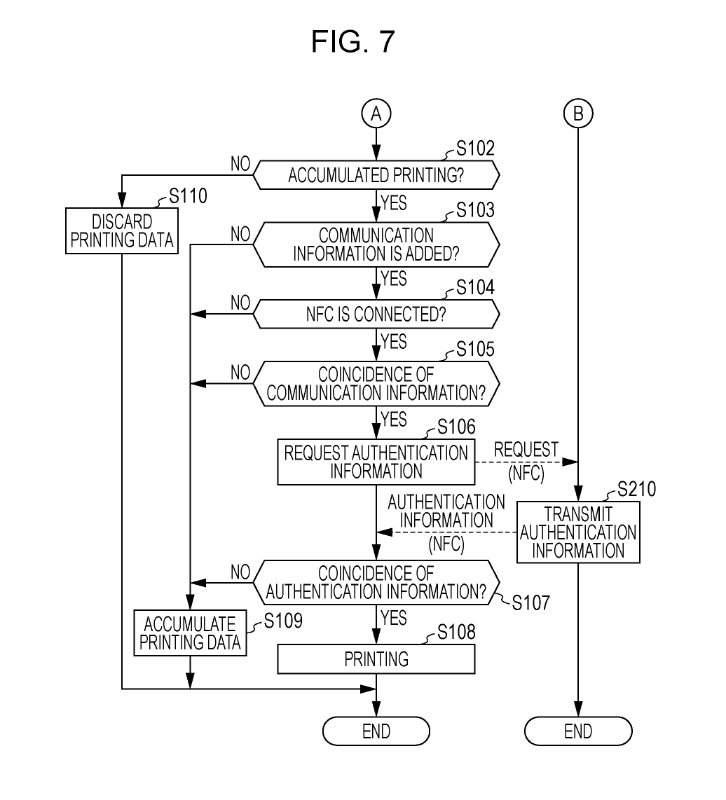

FIG. 6 and FIG. 7 are flowcharts illustrating an exemplary operational process in the second exemplary embodiment. The near field wireless communication unit 6 in the printer apparatus 100 continues to periodically send the query signal.

Referring to FIG. 6, in Step S201, the control unit 201 in the information processing apparatus 200 starts execution of an application program. Specifically, the user of the information processing apparatus 200 instructs the information processing apparatus 200 to execute the application program. The application program is a program for executing, for example, display of a document, editing, or printing. Upon start of the execution of the application program, the user selects a document to be printed to cause the display 206a to display the document and instructs the information processing apparatus 200 to start to make settings concerning the printing.

In Step S202, the near field wireless communication unit 203 receives the query signal sent from the near field wireless communication unit 6 in the printer apparatus 100.

In Step S203, the control unit 201 transmits the response signal to the printer apparatus 100 with the near field wireless communication unit 203.

In Step S101, upon reception of the response signal by the near field wireless communication unit 6 (the near field wireless communication unit 110), the NFC with the information processing apparatus 200 is established. The control unit 4 generates the communication information and stores the communication information in the RAM. The communication information is used for the NFC and is, for example, a session identifier (ID) for identifying the session of the NFC that is established. The control unit 4 transmits the communication information, the apparatus information, and the IP address to the information processing apparatus 200 with the near field wireless communication unit 6. The apparatus information is, for example, the information indicating the model of the printer apparatus 100. The IP address is the IP address allocated to the wireless LAN communication unit 7 and is used as the destination address when the printing data is transmitted from the information processing apparatus 200 to the printer apparatus 100 via the wireless LAN.

In Step S204, the control unit 201 receives the communication information and the apparatus information. The control unit 201 reads out the printer driver corresponding to the model of the printer apparatus 100 from the storage unit 5 on the basis of the received apparatus information and displays the setup screen of the printer driver in the display 1a. The user sets the print parameters on the setup screen and instructs transmission of the printing data. The print parameters include the printing range, the number of copies, and the one side printing or the duplex printing.

In Step S205, the control unit 201 determines whether the NFC with the printer apparatus 100 is kept. Specifically, the control unit 201 determines whether the near field wireless communication unit 203 receives the query signal within a predetermined period. The predetermined period is longer than the period in which the query signal is sent. If the query signal is received within the predetermined period, the control unit 201 determines that the NFC is kept (YES in Step S205). The process goes to Step S206. If the query signal is not received within the predetermined period, the control unit 201 determines that the NFC is not kept (NO in Step S205). The process goes to Step S208.

In Step S206, the control unit 201 generates the authentication information. Specifically, the control unit 201 generates the authentication information composed of, for example, a random number of multiple digits and stores the authentication information in the RAM. In this case, a numeric keypad used by the user to input the authentication information is not displayed in the display 206a.

In Step S207, the control unit 201 transmits the printing data to the printer apparatus 100. Specifically, the control unit 201 generates the printing data corresponding to the parameters (the printing range, the number of copies, and the one side printing or the duplex printing, etc.) set in Step S204, adds the type information, the authentication information, and the communication information to the printing data, and transmits the printing data to which type information, the authentication information, and the communication information are added to the printer apparatus 100 with the wireless LAN communication unit 204. The type information to be added to the printing data is the type information indicating the first type. The authentication information to be added to the printing data is the authentication information generated in Step S206. The communication information to be added to the printing data is the communication information received from the printer apparatus 100 in Step S204. The printing data to be generated may be data described in the page description language (PDL) or may be data described in combination of the PDL and the printer job language (PJL). The printing data may be data representing an image to be printed or may be data including the address of the location where the data representing the image to be printed is stored.

In Step S208, the accepting portion 206b accepts the authentication information. Specifically, the accepting portion 206b accepts the type information. When the user specifies the first type, the control unit 201 displays the numeric keypad used by the user to input the authentication information in the display 206a and the accepting portion 206b accepts the authentication information input with the numeric keypad to supply the authentication information to the control unit 201.

In Step S209, the control unit 201 transmits the printing data to the printer apparatus 100. Specifically, the control unit 201 generates the printing data corresponding to the parameters set in Step S204, adds the type information and the authentication information accepted in Step S208 to the printing data, and transmits the printing data to which the type information and the authentication information are added to the printer apparatus 100 with the wireless LAN communication unit 204.

Referring to FIG. 7, in Step S102, the control unit 4 in the printer apparatus 100 determines the type of the printing process. Specifically, upon reception of the printing data by the wireless LAN communication unit 7 (the receiving unit 130), the control unit 4 stores the printing data in the RAM to determine whether the type information indicating the first type (accumulated printing) is added to the printing data. If the type information indicating the first type is added to the printing data (YES in Step S102), the process goes to Step S103. If the type information indicating a type other than the first type is added to the printing data or no type information is added to the printing data (NO in Step S102), the process goes to Step 5110. In Step S110, the control unit 4 discards the printing data.

In Step S103, the control unit 4 (the second controller 160) determines whether the communication information is added to the printing data. If the communication information is added to the printing data (YES in Step S103), the process goes to Step S104. If no communication information is added to the printing data (NO in Step S103), the process geos to Step S109.

In Step S104, the control unit 4 (the second controller 160) determines whether the NFC with the information processing apparatus 200 is kept. Specifically, upon reception of the response signal to the query signal sent from the near field wireless communication unit 6, the control unit 4 determines that the NFC with the information processing apparatus 200 is kept (YES in Step S104). The process goes to Step S105. If the response signal is not received, the control unit 4 determines that the NFC with the information processing apparatus 200 is not kept (NO in Step S104). The process goes to Step S109.

In Step S105, the control unit 4 (the second controller 160) compares the communication information added to the printing data received from the information processing apparatus 200 with the communication information generated and stored in Step S101. If the communication information added to the printing data received from the information processing apparatus 200 coincides with the communication information generated and stored in Step S101 (YES in Step S105), the process goes to Step S106. If the communication information added to the printing data received from the information processing apparatus 200 does not coincide with the communication information generated and stored in Step 5101 (NO in Step S105), the process goes to Step S109.

In Step S106, the control unit 4 requests the information processing apparatus 200 to transmit the authentication information generated in the information processing apparatus 200 with the near field wireless communication unit 6. In this case, the control unit 4 does not accept the authentication information with the accepting portion 206b.

In Step S210, the control unit 201 in the information processing apparatus 200 transmits the authentication information generated and stored in Step S206 to the printer apparatus 100 with the near field wireless communication unit 203.

In Step S107, the control unit 4 compares the authentication information received from the information processing apparatus 200 with the authentication information added to the printing data received from the information processing apparatus 200. If the authentication information received from the information processing apparatus 200 coincides with the authentication information added to the printing data received from the information processing apparatus 200 (YES in Step S107), the process goes to Step S108. If the authentication information received from the information processing apparatus 200 does not coincide with the authentication information added to the printing data received from the information processing apparatus 200 (NO in Step S107), the process goes to Step S109.

In Step S108, the control unit 4 (the second controller 160) supplies the printing data to the image processing unit 3. The image processing unit 3 (the printing unit 120) converts the printing data into the raster data to perform the image processing to the rater data and supplies the raster data subjected to the image processing to the image forming unit 10. The image forming unit 10 prints an image based on the raster data. Upon completion of the printing, the process concerning the printing data is terminated.

If the determination in Step S103, S104, S105, and S107 is negative (NO), the control unit 4 does not print an image based on the printing data received from the information processing apparatus 200. The process goes to Step S109. In Step S109, the control unit 4 stores the printing data in the storage unit 5. Then, the process concerning the printing data is terminated.

In response to the subsequent instruction to execute the accumulated printing to the UI unit 1 from the user, the control unit 4 displays the user ID corresponding to each piece of printing data that is accumulated in the display 1a. Upon selection of a user ID and input of the authentication information by the user, the accepting portion 1b (the accepting unit 140) accepts the user ID and the authentication information to supply the user ID and the authentication information to the control unit 4. The control unit 4 (the first controller 150) reads out the printing data to which the user ID and the authentication information are added from the storage unit 5 to cause the image forming unit 10 (the printing unit 120) to print the printing data.

### Modifications

The above exemplary embodiments may be modified in the following manner. Multiple exemplary modifications may be combined.

Steps S106, S210, and S107 in the second exemplary embodiment may be omitted.

Step S206 in the second exemplary embodiment may be omitted. In this case, the authentication information is not added to the printing data in Step S207.

In Steps S207 and S209 in the second exemplary embodiment, the printing data may be transmitted without adding the type information to the printing data. In this case, the printer apparatus 100 may be set so as to perform only the accumulated printing.

Although the example is described in the second exemplary embodiment in which the second controller 160 causes the printing unit 120 to print the printing data without the authentication using the authentication information if the communication information is added to the printing data received by the receiving unit 130, the near field wireless communication with the information processing apparatus 200 is kept, and the communication information added to the printing data coincides with the communication information concerning the near field wireless communication that is kept, the second controller 160 may be modified in the following manner. For example, the second controller 160 may cause the printing unit 120 to print the printing data without the authentication using the authentication information if the near field wireless communication with the information processing apparatus 200 is kept. Specifically, Steps S103 and S105 in FIG. 7 are omitted. In this case, it is not necessary to add the communication information to the printing data in Step S207.

Alternatively, the second controller 160 may cause the printing unit 120 to print the printing data without the authentication using the authentication information if the communication information concerning the near field wireless communication with the information processing apparatus 200 is added to the printing data received by the receiving unit 130. Specifically, Steps S104 and S105 in FIG. 7 are omitted.

Alternatively, the second controller 160 may cause the printing unit 120 to print the printing data without the authentication using the authentication information if the communication information is added to the printing data received by the receiving unit 130 and the near field wireless communication with the information processing apparatus 200 is kept. Specifically, Step S105 in FIG. 7 is omitted.

In sum, it is sufficient for the second controller 160 to be configured so as to cause the printing unit 120 to print the printing data without the authentication using the authentication information if the printing data is received by the receiving unit 130 after the near field wireless communication with the information processing apparatus 200 by the near field wireless communication unit 110 is performed.

The example in which the communication information is the session ID is described in the second exemplary embodiment, the communication information may be, for example, information indicating that the near field wireless communication with the information processing apparatus 200 is started. In sum, it is sufficient for the communication information to concern the near field wireless communication with the information processing apparatus 200.

The following processing may be added to the second exemplary embodiment. For example, the second controller 160 may stop the printing if the near field wireless communication with the information processing apparatus 200 is disconnected while the printing by the printing unit 120 is being performed.

Alternatively, the second controller 160 may not perform the processing based on the printing data transmitted from an apparatus other than the information processing apparatus 200 if the near field wireless communication with the information processing apparatus 200 is kept. For example, the wireless LAN communication unit 7 may not receive the printing data. Alternatively, the IP address of the transmission source included in the header of the received printing data may be compared with the IP address of the information processing apparatus 200 with which the near field wireless communication is kept and the printing data may be deleted if the IP address of the transmission source included in the header of the received printing data does not coincide with the IP address of the information processing apparatus 200 with which the near field wireless communication is kept. Alternatively, the received printing data may be held without being printed while the near field wireless communication with the information processing apparatus 200 is being kept. Alternatively, the printing data received from an apparatus other than the information processing apparatus 200 may be held without being printed before the printing data is received from the information processing apparatus 200 with which the near field wireless communication is kept.

The configuration in which Steps S106, S210, and S107 in the second exemplary embodiment are omitted may be realized by a printer apparatus including a near field wireless communication unit, a printing unit, a receiving unit that receives printing data from an information processing apparatus, an accepting unit that accepts authentication information, a first controller that controls the printing unit so that the printing data received by the receiving unit is printed if authentication using the authentication information accepted by the accepting unit succeeded, and a second controller that, if the printing data and authentication information are received by the receiving unit in a state in which near field wireless communication with the information processing apparatus by the near field wireless communication unit is kept, controls the printing unit so that the printing data is printed without the authentication using the authentication information.

The information processing apparatus 200 may be a mobile phone, a tablet personal computer, or a notebook-sized personal computer. The wireless LAN may be in an infrastructure mode. A wired LAN may be used, instead of the wireless LAN.

The example is described above in the exemplary embodiments in which the information processing apparatus 200 and the printer apparatus 100 execute the programs to realize the above functions, the programs may be recorded in a computer-readable recording medium, such as an optical recording medium or a semiconductor memory, to be provided and the programs may be read out from the recording medium to be installed in the information processing apparatus 200 and the printer apparatus 100. The programs may be provided through an electric communication line. Functions similar to those in the exemplary embodiments may be implemented in the information processing apparatus 200 and the information processing apparatus 200 as the hardware.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A printer apparatus comprising:
a near field wireless communication unit;
a printing unit;
a receiving unit that receives printing data from an information processing apparatus;
an accepting unit that accepts authentication information;
a first controller that controls the printing unit so that the printing data received by the receiving unit is printed if authentication using the authentication information accepted by the accepting unit becomes successful; and
a second controller that controls the printing unit so that the printing data is printed without the authentication using the authentication information if the printing data is received by the receiving unit after near field wireless communication with the information processing apparatus by the near field wireless communication unit is performed.

2. The printer apparatus according to claim 1,
wherein the near field wireless communication unit uses near field communication.

3. The printer apparatus according to claim 1,
wherein the receiving unit uses communication via a wireless LAN.

4. The printer apparatus according to claim 1,
wherein the second controller causes the printing unit to print the printing data without the authentication using the authentication information if communication information concerning the near field wireless communication with the information processing apparatus is added to the printing data received by the receiving unit.

5. The printer apparatus according to claim 4,
wherein the communication information is information for identifying a session of the near field wireless communication with the information processing apparatus.

6. The printer apparatus according to claim 1,
wherein the second controller causes the printing unit to print the printing data without the authentication using the authentication information if the near field wireless communication with the information processing apparatus is kept.

7. The printer apparatus according to claim 6,
wherein the second controller stops printing if the near field wireless communication with the information processing apparatus is disconnected during the printing with the printing unit.

8. The printer apparatus according to claim 6,
wherein the second controller does not perform processing based on printing data transmitted from an apparatus other than the information processing apparatus if the near field wireless communication with the information processing apparatus is kept.

9. The printer apparatus according to claim 7,
wherein the second controller does not perform processing based on printing data transmitted from an apparatus other than the information processing apparatus if the near field wireless communication with the information processing apparatus is kept.

10. The printer apparatus according to claim 1,
wherein the second controller performs the authentication using the authentication information accepted by the accepting unit if the near field wireless communication with the information processing apparatus is not kept and causes the printing unit to print the printing data if the authentication becomes successful.

11. The printer apparatus according to claim 4,
wherein the second controller causes the printing unit to print the printing data without the authentication using the authentication information if the communication information is added to the printing data received by the receiving unit, the near field wireless communication with the information processing apparatus is kept, and the communication information coincides with communication information concerning the near field wireless communication that is kept.

12. The printer apparatus according to claim 11,
wherein the communication information is information for identifying a session of the near field wireless communication with the printer apparatus.

13. The printer apparatus according to claim 1,
wherein the first controller determines that the authentication becomes successful if the authentication information added to the printing data received by the receiving unit coincides with the authentication information accepted by the accepting unit.

14. A printer apparatus comprising:
a near field wireless communication unit;
a printing unit;
a receiving unit that receives printing data from an information processing apparatus;
an accepting unit that accepts authentication information;
a first controller that controls the printing unit so that the printing data received by the receiving unit is printed if authentication using the authentication information accepted by the accepting unit becomes successful; and
a second controller that, if the printing data and authentication information are received by the receiving unit in a state in which near field wireless communication with the information processing apparatus by the near field wireless communication unit is kept, controls the printing unit so that the printing data is printed without the authentication using the authentication information.

15. A non-transitory computer readable medium storing a program causing a computer that controls a printer apparatus to execute a process comprising:
performing near field wireless communication;
receiving printing data from an information processing apparatus;
accepting authentication information;
controlling the printer apparatus so that the received printing data is printed if authentication using the accepted authentication information becomes successful; and
controlling the printer apparatus so that the printing data is printed without the authentication using the authentication information if the printing data is received after the near field wireless communication with the information processing apparatus is performed.

16. A non-transitory computer readable medium storing a program causing a computer that controls a printer apparatus to execute a process comprising:
performing near field wireless communication;
receiving printing data from an information processing apparatus;
accepting authentication information;
controlling the printer apparatus so that the received printing data is printed if authentication using the accepted authentication information becomes successful; and
controlling, if the printing data and authentication information are received in the receiving in a state in which the near field wireless communication with the information processing apparatus is kept, the printer apparatus so that the printing data is printed without the authentication using the authentication information.

17. A printing method for a printer apparatus, the printing method comprising:
performing near field wireless communication;
receiving printing data from an information processing apparatus;
accepting authentication information;
controlling the printer apparatus so that the received printing data is printed if authentication using the accepted authentication information becomes successful; and
controlling the printer apparatus so that the printing data is printed without the authentication using the authentication information if the printing data is received after the near field wireless communication with the information processing apparatus is performed.
